(19) United States
(12) Patent Application Publication
(10) Pub. No.: US 2026/0292896 A1
(43) Pub. Date: Sep. 24, 2026

(54) PRACH CONFIGURATION FOR MULTI-TRP

(71) Applicant: Telefonaktiebolaget LM Ericsson (publ), Stockholm (SE)

(72) Inventors: Helka-Liina MÄÄTTÄNEN, ESPOO (FI); Henrik ENBUSKE, STOCKHOLM (SE); Shiwei GAO, NEPEAN (CA); Siva MURUGANATHAN, STITTSVILLE (CA)

(73) Assignee: Telefonaktiebolaget LM Ericsson (publ), Stockholm (SE)

(21) Appl. No.: 19/472,858

(22) PCT Filed: Apr. 5, 2024
(86) PCT No.: PCT/IB2024/053360

§ 371 Date: Oct. 6, 2025

Related U.S. Application Data
(60) Provisional application No. 63/457,331, filed on Apr. 5, 2023.

(51) Int. Cl. H04W 74/0838; H04W 72/23; H04W 74/00

(52) U.S. Cl. CPC H04W 74/0838; H04W 72/23; H04W 74/006

(57) ABSTRACT

A method performed by a UE in a wireless communication network is disclosed in which the UE is configured with two TAGs and is configured with a first CORESET associated to a first CORESET pool index and a second CORESET associated to a second CORESET pool index. The method includes receiving a first RACH configuration associated to a first PCI for CFRA, wherein the first PCI is associated to the first CORESET, receiving one or more second RACH configurations associated to one or more respective second PCIs for CFRA, where the one or more second PCIs are associated to the second CORESET, receiving an indication of an activated second PCI of the one or more second PCIs and a request of CFRA associated to the activated second PCI, and performing a CFRA according to one of the one or more second RACH configurations associated to the activated second PCI.

### RELATED APPLICATION

The present application claims the benefit of and priority to U.S. Provisional Patent Application No. 63/457,331, filed Apr. 5, 2023, entitled “PRACH CONFIGURATION FOR MULTI-TRP,” the disclosure of which is hereby incorporated herein by reference in its entirety.

### TECHNICAL FIELD

The present disclosure relates to wireless communication networks, and in particular to methods of performing contention free random access in a wireless communication network.

### BACKGROUND

In a wireless communication network, different user equipment devices (e.g., user equipment, or UEs) in the same cell may typically be located at different positions within the cell and then with different distances to the base station (e.g. a gNodeB in a New Radio, NR, communication system). The transmissions from different UEs may therefore suffer from different delays until they reach the base station. To make sure that the uplink (UL) transmissions from a UE reaches the base station within the corresponding receive window for the base station, an uplink timing control procedure is used. This may help to avoid intracell interference occurring, both between UEs assigned to transmit in consecutive subframes and between UEs transmitting on adjacent subcarriers.

Time alignment of the uplink transmissions is achieved by applying a timing advance at the UE transmitter, relative to the received downlink timing. The main role of this is to counteract differing propagation delays between different UEs, as shown in FIG. 1 for an eNodeB in a Long Term Evolution (LTE) communication system. In particular, FIG. 1 illustrates time alignment of uplink transmissions for a case (a) without timing advance and for a case (b) with timing advance.

To achieve the time alignment and thereby obtain UL synchronization, the base station (e.g. gNodeB, eNodeB) derives a timing advance (TA) value that the UE needs to use for the UL transmissions in order to reach the base station within the receive window and indicates this to the UE. When the UE first accesses a cell, it uses the random-access procedure where the received Msg1 (the physical random access channel, PRACH, preamble) is used by the base station to determine the UE's initial TA to use for UL transmissions in the cell. During the connection, the base station then continuously monitors whether the UE needs to advance/delay the UL transmissions, in order to compensate for changes in propagation delay, and indicates to the UE if there is a need to change the timing advance value.

Initial Timing Advance and Timing Advance Group (TAG) configuration

The initial TA value is obtained when the UE performs a random access, e.g., when performing a transition from IDLE (or INACTIVE) to CONNECTED state. After a UE has first synchronized its receiver to the downlink transmissions received from the gNodeB (e.g., by monitoring the synchronization signal blocks (SSBs) of the cell the UE wants to access), the initial timing advance is set by the UE transmitting a random access preamble from which the gNodeB estimates the uplink timing value contained within the Random Access Response (RAR) message. This allows the timing advance to be configured by the gNodeB.

### Physical RACH Procedure

Prior to initiation of the physical random access procedure, Layer 1 (the physical layer) receives from higher layers a set of synchronization signal/physical broadcast channel (SS/PBCH) block indexes and provides to higher layers a corresponding set of reference signal received power (RSRP) measurements.

A physical random access procedure is triggered upon request of a physical random access channel (PRACH) transmission by higher layers or by a physical downlink control channel (PDCCH) order. A configuration by higher layers for a PRACH transmission includes the following:
A configuration for PRACH transmission according to [1].
A preamble index, a preamble subcarrier spacing (SCS), PRACH target receive power, a corresponding random access channel radio network temporary identifier (RA-RNTI), and a PRACH resource.

A PRACH preamble is transmitted according to the PRACH configuration with a transmission power on the indicated PRACH resource.

A PRACH configuration can be cell-specific or UE-specific. A cell-specific PRACH configuration is via a RACH-ConfigCommon information element (IE), while a UE-specific PRACH configuration is done via a RACH-ConfigDedicated IE, both are described in [2].

For Type-1 random access procedure, a UE is provided with a total number, N_{preamble}^{total}, of PRACH preambles for both contention-based random access (CBRA) and contention-free random access (CFRA) in each PRACH occasion. The default is N_{preamble}^{total}=64 if it is not configured. The UE is also provided a number N of synchronization signal/physical broadcast channel (SS/PBCH) block indexes associated with one PRACH occasion and a number R of contention based preambles per SS/PBCH block index per valid PRACH occasion by a parameter called ssb-perRACH-OccasionAndCB-PreamblesPerSSB contained in the RACH-ConfigCommon IE.

If N<1, one SS/PBCH block index is mapped to I/N consecutive valid PRACH occasions and R contention-based preambles with consecutive indexes associated with the SS/PBCH block index per valid PRACH occasion start from preamble index 0. An example is shown in FIG. 2, where N=1/2, R=32, N_{preamble}^{total}=64, and 4 SSBs.

FIG. 2 illustrates an example of SSB to PRACH preamble mapping with N=1/2 and R=32.

If N≥1, R contention based preambles with consecutive indexes associated with SS/PBCH block index n, 0≤n≤N−1, per valid PRACH occasion start from preamble index n(N_{preamble}^{total})/N. An example is shown in FIG. 3, where N=4, R=4, N_{preamble}^{total}=64, and 4 SSBs. For each PRACH occasion, PRACH preambles 0 to 3 are allocated to SSB #0 for CBRA and PRACH preambles 4 to 15 are allocated to SSB #0 for CFRA, PRACH preambles 16 to 19 are allocated to SSB #1 for CBRA and PRACH preambles 20 to 31 are allocated to SSB #1 for CFRA, and so on. FIG. 3 illustrates an example of SSB to PRACH preamble mapping with N=4 and R=4.

Association of CFRA preambles with SSBs can also be reconfigured via a higher parameter ssb-perRACH-Occasion in the RACH-ConfigDedicated IE, in which the UE is provided with information about a number N of SS/PBCH block indexes associated with one PRACH occasion. The UE may also provide information about a mapping between a SSB or a channel state information reference signal (CSI-RS) index and a preamble index in a PRACH occasion.

### PDCCH Order-Initiated RACH Procedure

A RACH procedure can be initiated by either the gNodeB or the UE. It can be contention based (CB) or contention free (CF). A RACH procedure can be initiated by a physical downlink control channel (PDCCH) order sent from the gNodeB to the UE for synchronizing the UL when UL time alignment may have been lost. PDCCH order is carried by downlink control information (DCI) format 1-0 when the DCI's cyclic redundancy code (CRC) is scrambled by a UE's Cell Radio Network Temporary Identifier (C-RNTI) and the “Frequency domain resource assignment” field of the DCI contains all ones. The PDCCH order contains the following information:
Random Access Preamble index: 6 bits according to a higher layer parameter “ra-PreambleIndex” in Clause 5.1.2 of [3].
SS/PBCH index: 6 bits, If the value of the “Random Access Preamble index” is not all zeros, this field indicates the SS/PBCH that shall be used to determine a RACH (random access channel) occasion for PRACH (Physical random access channel) transmission; otherwise, this field is reserved.
PRACH Mask index. If the value of the “Random Access Preamble index” is not all zeros, this field indicates the RACH occasion associated with the SS/PBCH indicated by “SS/PBCH index” for the PRACH transmission, according to Clause 5.1.1 of [3]; otherwise, this field is reserved.

If the PRACH preamble index is non-zero, a contention free random access (CFRA) procedure is triggered, in which the PRACH preamble is allocated only for the UE in a corresponding PRACH resource.

If the PRACH preamble index is zero, and CFRA PRACH resources associated with SSBs have been provided in a UE specific RACH configuration in the rach-ConfigDedicated IE, the UE first selects an SSB with SSB based Reference Signal Received Power (SS-RSRP) above a configured threshold, then selects a PRACH preamble according to the selected SSB. If the PRACH preamble index is zero, and CFRA resources associated with CSI-RSs have been provided in the rach-ConfigDedicated IE, the UE first selects an CSI-RS with CSI-RSRP above a configured threshold, rsrp-ThresholdCSI-RS, then selects a PRACH preamble according to the selected CSI-RS. If the PRACH preamble index is zero and the CFRA PRACH resources associated with SSB or CSI-RS are not provided, a CBRA procedure is triggered by the PDCCH order, in which the UE selects a PRACH preamble randomly from a set of PRACH preambles configured for CBRA in the serving cell. Note that in this case, the same preamble could be selected by more than one UE in a same PRACH resource and contention could occur. PDCCH order triggered CBRA is only allowed for a SpCell, i.e., a primary cell in either a master cell group (MCG) or a secondary cell group (SCG), if cell groups are configured. The rach-ConfigDedicated IE is described in [2], the detailed procedure is described in Clause 5.1.2 of [3].

If a UE is configured with two UL carriers for a serving cell and the UE detects a PDCCH order, the UE uses the UL/SUL indicator field value from the detected PDCCH order to determine the UL carrier for the corresponding PRACH transmission.

A RACH occasion is a time and frequency resource, i.e., a number of RBs in a number of orthogonal frequency division multiplexing (OFDM) symbols, allocated for PRACH transmission, multiple RACH occasions may be configured in a PRACH configuration period consisting multiple radio frames. RACH occasions may be multiplexed either in time or frequency.

From the physical layer perspective, the random access procedure triggered by a PDCCH order includes the transmission of random access preamble (Msg1) in a PRACH by a UE, the transmission of a random access response (RAR) message with a PDCCH and a corresponding physical downlink shared channel (PDSCH) (Msg2), and when applicable, the transmission of a physical uplink shared channel (PUSCH) scheduled by a RAR UL grant, and PDSCH for contention resolution if the RACH procedure is contention based.

### Multi-TRP

In 3GPP Rel-17, the work for multi-TRP done in Rel-16 is being extended to an inter-cell scheme. Multiple transmit-receive point (mTRP) transmission is essentially non-coherent Joint Transmission (NC-JT) over multiple transmission and reception points (TRPs). NC-JT refers to multiple input-multiple output (MIMO) data transmission over multiple TRPs in which different MIMO layers are transmitted over different TRPs. Two ways of scheduling NC-JT multi-TRP transmission are specified in NR Rel-16: multi-PDCCH based multi-TRP transmission and single-PDCCH based multi-TRP transmission.

### Multi-PDCCH Based Multi-TRP Transmission

An example is shown in FIG. 4, which illustrates an example of multi-PDCCH based multi-TRP transmission with a single scheduler. In FIG. 4, data are sent to a UE over two TRPs, each TRP carrying one Transport Block (TB) mapped to one code word. When the UE has 4 receive antennas and each of the TRPs has only 2 transmit antennas, the UE can support up to 4 MIMO layers but each TRP can maximally transmit 2 MIMO layers. In this case, by transmitting data over two TRPs to the UE, the peak data rate to the UE can be increased, as up to 4 aggregated layers from the two TRPs can be used. This is beneficial when the traffic load, and thus the resource utilization, is low in each TRP. In this example, a single scheduler is used to schedule data over the two TRPs.

One PDCCH is transmitted from each of the two TRPs in a slot, each scheduling one PDSCH. This is referred to as a multi-PDCCH or multi-DCI scheme in which a UE receives two PDCCHs and the associated two PDSCHs in a slot from two TRPs.

In another scenario shown in FIG. 5, which illustrates an example of multi-PDCCH based multi-TRP transmission with independent schedulers. In this case, only semi-static to semi-dynamic coordination between the two schedulers can be done due the non-ideal backhaul, i.e., backhaul with large delay and/or delay variations which are comparable to the cyclic prefix length or in some cases even longer, up to several milliseconds.

Although FIGS. 4 and 5 show multi-DCI scheduling for the PDSCH, multi-DCI scheduling for the PUSCH is also supported in NR Rel-16. In NR Rel-16, multi-DCI scheduling is for multi-TRP in which a UE may receive two DCIs each scheduling a PDSCH/PUSCH. Each PDCCH and PDSCH are transmitted from the same TRP. An example is shown FIG. 6, which illustrates an example of PDSCH transmission with multi-DCI with multiple TRPs. In FIG. 6, PDSCH 1 is scheduled by PDCCH 1 from TRP1 and PDSCH 2 is scheduled by PDCCH 2 from TRP2. The two PDSCHs may be fully, partially or non-overlapping in time and frequency. When the two PDSCHs are fully or partially overlapping, a same demodulation reference signal (DMRS) resource configuration is assumed with DMRS ports of the two PDSCHs in different code division multiplexing (CDM) groups. Multi-DCI scheduling can also be used to schedule PUSCH towards different TRPs. In the case of PUSCH scheduling, the PUSCH transmissions towards different TRPs are time-division-multiplexed in NR Rel-16. In NR Rel-18, multi-DCI based multi-TRP is being extended to the case where two PDCCHs from TRP1 and TRP2 schedule PUSCH1 and PUSCH2, respectively, where PUSCH1 and PUSCH2 may be transmitted simultaneously in overlapping OFDM symbols in time domain by the UE.

For multi-DCI operation, a UE needs to be configured with two control resource set (CORESET) pools, each associated with a TRP. Each CORESET pool is a collection of CORESETs that belong to the same pool. A CORESET pool index can be configured in each CORESET with a value of 0 or 1. For the two DCIs in the above example, they are transmitted in two CORESETs belonging to different CORESET pools (i.e. with CORESETPoolIndex 0 and 1 respectively). The two PDSCHs belong to two different hybrid automatic repeat request (HARQ) processes.

### “Intercell” Multi-TRP Transmission

In Release 17 a concept called “intercell” mTRP is introduced. The term is used here within quotations, as what is introduced is not “intercell” in the sense of serving cells but in the sense of SSB sets/physical cell identities (PCIs). That is, a list of SSBs with different PCI(s) from that of the serving cell is introduced within a serving cell configuration.

The intercell aspect of Rel-17 refers to the case when these two TRPs are associated to different SSB associated with different PCIs. That is, the TCI state that refers to transmission from TRP 1 or TRP 2 is quasi-collocated to a reference signal that either is one of the SSB beams with the PCI belonging to that TRP, or another reference signal such as CSI-RS or DMRS that has a root quasi-colocation assumption to one of the SSB beams with PCI belonging to that TRP.

In case that one of the TRPs is associated to a different PCI than the PCI of the serving cell, the different PCI is also referred to as additional PCI and is provided to the UE by a higher layer parameter “additionalPCI-r17” in a SSB-MTC-AdditionalPCI-r17 IE shown below according to [2]. The SSB-MTC-AdditionalPCI-r17 IE shown in Table 1 provides also information about the SSBs associated to the additional PCI.

TABLE 1
SSB-MTC-AdditionalPCI-r17 IE

SSB-MTC information element
-- ASN1START
-- TAG-SSB-MTC-START
(unrelated text ommited)

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, |

ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}
AdditionalPCIIndex-r17 ::= INTEGER(1..maxNrofAdditionalPCI-r17)
-- TAG-SSB-MTC-STOP
-- ASN1STOP

Multiple SSB-MTC-AdditionalPCI-r17 IEs may be configured for a UE in a serving cell, each associated to an additional PCI. Each of the multiple SSB-MTC-AdditionalPCI-r17 IEs is assigned an index, “AdditionalPCIIndex-r17”, which has a range from 1 to a maximum number of additional PCIs that can be configured. The multiple SSB-MTC-AdditionalPCI-r17 IEs are configured as “additionalPCI-ToAddModList-r17” in the ServingCellConfig IE shown in Table 2 according to [2].

TABLE 2
ServingCellConfig IE

ServingCellConfig information element
-- ASN1START
-- TAG-SERVINGCELLCONFIG-START
(unrelated text ommited)
MIMOParam-r17 ::= SEQUENCE {

| | |
|---|---|
| additionalPCI-ToAddModList-r17 | SEQUENCE (SIZE(1..maxNrofAdditionalPCI- |
| r17)) OF SSB-MTC-AdditionalPCI-r17 | OPTIONAL, -- Need N |
| additionalPCI-ToReleaseList-r17 | SEQUENCE (SIZE(1..maxNrofAdditionalPCI- |
| r17)) OF AdditionalPCIIndex-r17 | OPTIONAL, -- Need N |

(unrelated text omitted)
}
-- TAG-SERVINGCELLCONFIG-STOP
-- ASN1STOP

### PRACH Dedicated

A PRACH configuration is given to the UE in the CellGroupConfig IE, which is used to configure a MCG or SCG. A cell group comprises of one medium access control (MAC) entity, a set of logical channels with associated RLC entities and of a primary cell (SpCell) and one or more secondary cells (SCells).

Within that IE the PRACH configuration is given with the IE Reconfiguration WithSync. The IE RACH-ConfigDedicated is used to specify the dedicated random access parameters.

### SUMMARY

Some embodiments provide efficient configuration options for a UE with RACH configuration when the UE is configured with mTRP operation and with additional PCI and two timing advance timers/timing advance group (TAG) groups per serving cell.

In particular, some embodiments provide a method performed by a UE in a wireless communication network. The UE is configured with two TAGs and is configured with a first CORESET associated to a first CORESET pool index and a second CORESET associated to a second CORESET pool index. The method includes receiving a first RACH configuration associated to a first PCI for CFRA, wherein the first PCI is associated to the first CORESET, receiving one or more second RACH configurations associated to one or more respective second PCIs for CFRA, where the one or more second PCIs are associated to the second CORESET, receiving an indication of an activated second PCI of the one or more second PCIs and a request of CFRA associated to the activated second PCI, and performing a CFRA according to one of the one or more second RACH configurations associated to the activated second PCI.

Some further embodiments provide a method performed by a UE in a wireless communication network that includes receiving a first RACH configuration for CFRA to a first PCI associated with a first CORESET associated to a first CORESET pool index, and performing a CFRA toward a second PCI for multi-TRP operation using the first RACH configuration.

Some embodiments provide a method performed by network node in a wireless communication network. The method includes configuring a UE with a first RACH configuration for CFRA to a first PCI associated with a first CORESET associated to a first CORESET pool index, and configuring the UE with a plurality of second RACH configurations for a respective second plurality of PCIs associated to a second CORESET that is associated to a second CORESET pool index for multi-TRP operation.

Some further embodiments provide a method performed by a network node in a wireless communication network that includes configuring a UE with a RACH configuration for CFRA to a first PCI associated with a first CORESET associated to a first CORESET pool index, and configuring the UE with a configuration for a second PCI associated with a second CORESET for multi-TRP operation. The UE applies the RACH configuration when performing a CFRA to the second PCI for multi-TRP operation.

Some embodiments also provide a wireless device/UE and a network node for performing the above methods.

### BRIEF DESCRIPTION OF THE DRAWINGS

FIG. 1 illustrates time alignment of uplink transmissions for a case (a) without timing advance and for a case (b) with timing advance.

FIG. 2 illustrates an example of SSB to PRACH preamble mapping with N=1/2 and R=32.

FIG. 3 illustrates an example of SSB to PRACH preamble mapping with N=4 and R=4.

FIG. 4 illustrates an example of multi-PDCCH based multi-TRP transmission with a single scheduler.

FIG. 5 illustrates an example of multi-PDCCH based multi-TRP transmission with independent schedulers.

FIG. 6 illustrates an example of PDSCH transmission with multi-DCI with multiple TRPs.

FIG. 7 illustrates a detail of a mapping of contention free preambles (CFPR) to an SSB.

FIGS. 8A and 8B are signal flow diagrams illustrating message flows and

associated operations according to some embodiments.

FIGS. 9A and 9B illustrate methods performed by a UE in a wireless communication network.

FIGS. 10A and 10B illustrate methods performed by a network node in a wireless communication network.

FIG. 11 shows an example of a communication system in accordance with some embodiments.

FIG. 12 shows a UE in accordance with some embodiments.

FIG. 13 shows a network node in accordance with some embodiments.

FIG. 14 is a block diagram of a host in accordance with some embodiments.

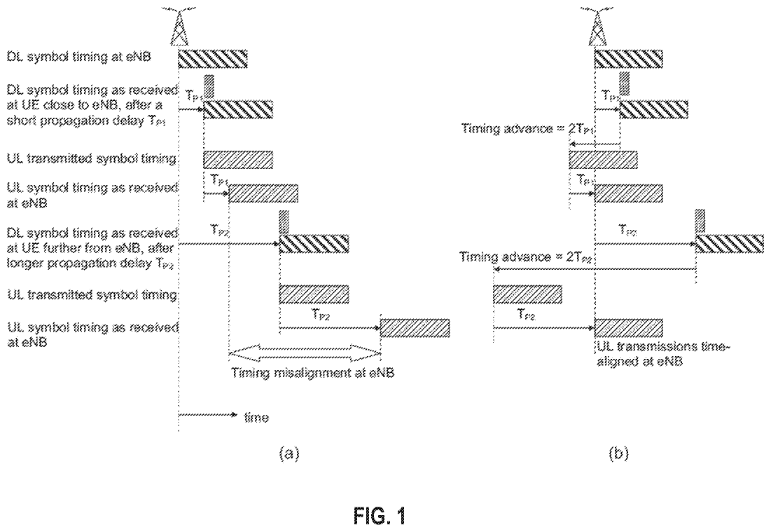

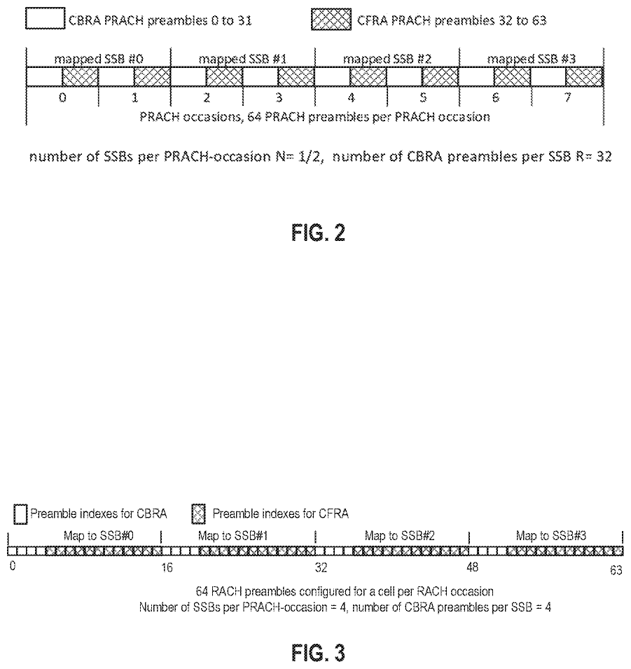

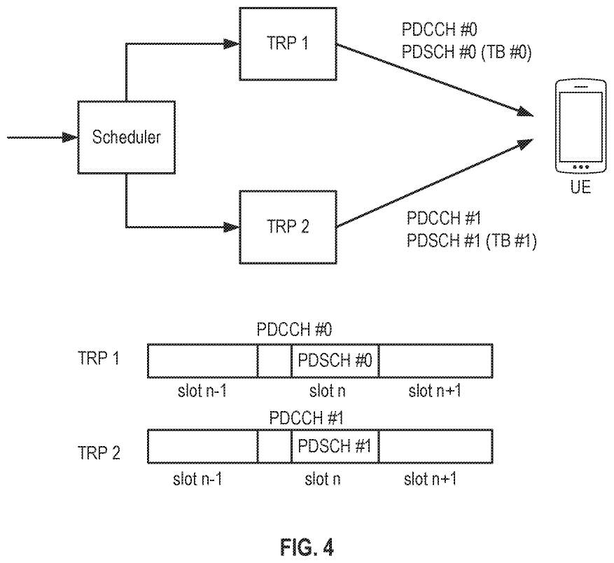

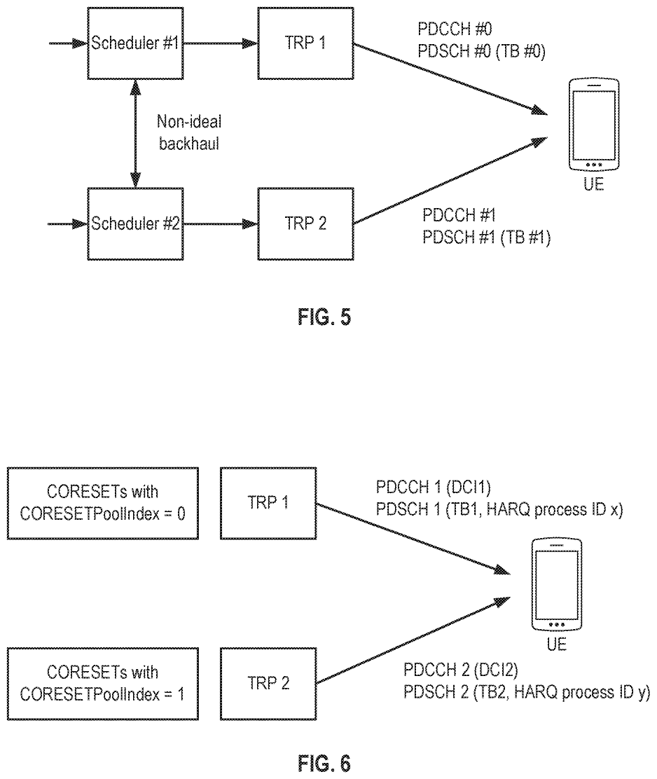

### DETAILED DESCRIPTION OF EMBODIMENTS

For multi-DCI based inter-cell Multi-TRP operation with two TA enhancement, one additional PRACH configuration is supported for each configured additional PCI. The additional PRACH configuration is used in a RACH procedure triggered by a PDCCH order for the corresponding configured additional PCI.

However, how the configuration can be extended to multi-TRP where a serving cell is configured with two timing advance values/timing advance groups is an open issue. The RAN1 3GPP group has agreed to have one additional PRACH configuration for each configured additional PCI. However, from the perspective of the RAN2 3GPP group, the RACH procedure for any of the additional PCI/SSBs is towards the same MAC entity as the original PCI/SSB. Hence simply adding whole PRACH configurations for each configured additional PCI may not be feasible.

Certain aspects of the disclosure and their embodiments may provide solutions to these or other challenges. Some embodiments described herein provide efficient methods for configuring a UE with a RACH configuration when the UE is configured with mTRP operation and with additional PCI and two timing advance timers/TAG groups per serving cell.

For example, in some embodiments, the original RACH configuration for contention free random access given to UEs may be applied to the TRP using the SSBs of an additional PCI. Note that up to 7 additional PCI/SSBs may be configured for the UE. One of the additional PCI/SSBs may be active at the time and associated to the second TRP while the first TRP is associated to the original PCI/SSB of the serving cell.

Certain embodiments may provide one or more of the following technical advantage(s). Rather than simply repeating a RACH-ConfigDedicated configuration, other options for the configuration are provided. The signaling may be more efficient, as some fields and parameters may be shared among, e.g., additional PCI/SSBs configured for the UE. Another advantage is that when existing RACH configurations are not reused, the existing specification text (e.g. Clause 5.3.5.8.3 of [2]) in the procedural section does not need to be modified and hence difficulties related to backwards compatibility may be reduced.

Some of the embodiments contemplated herein will now be described more fully with reference to the accompanying drawings. Embodiments are provided by way of example to convey the scope of the subject matter to those skilled in the art.

In a first embodiment, the original RACH configuration for contention free random access given to UEs is applied to the TRP using the SSBs of an additional PCI. Note that up to 7 additional PCI/SSBs may be configured for the UE while one of those is active at the time and associated to the second TRP, while the first TRP is associated to the original PCI/SSB of the serving cell.

In a variant of the first embodiment, only the root sequence, configured for example with prach-RootSequenceIndex, is given per additional PCI/SSB (for each seven of them separately).

In a second embodiment, the IE RACH-ConfigDedicated and or RACH-ConfigCommon are used as-is to give UE the needed additional CFRA configurations for the second TRP. This may be done such that there is one additional CFRA configuration for the second TRP which is used regardless of the associated additional PCI/SSB. In a variant, only the root sequence configured e.g. with prach-RootSequenceIndex is given per additional PCI/SSB (for each seven of them separately). In a variant, each additional PCI/SSB receives its own full CFRA configuration.

In a variant of the second embodiment, the needed configuration is given by one of the sub IEs, such as a CFRA IE.

In one embodiment, the RACH-ConfigDedicated IE is extended to include additional RACH configurations for the second TRP associated to an additional PCI, or for each additional PCI/SSB separately. An example is shown in Table 3. As shown in Table 3, CFRA-Additional configured for an additional PCI contains at least one of:
a rach-ConfigGeneric field that provides configuration of contention free random-access occasions for CFRA specific to the additional PCI;
a ssb-perRACH-Occasion that configures the number of SSBs per RACH occasions;
a prach-RootSequenceIndex which provides PRACH root sequence index corresponding to the additional PCI;
optionally, an additionalPCIIndex, which is an index of the additional PCI when more than one additional PCI is configured to the UE (e.g., when X number of additional PCIs are configured, the additionalPCIIndex provides the integer index between 1 and X to which the configured cfra-Additional parameter corresponds to);
optionally, an additionalPCI which provides the physical cell ID PhysCellId corresponding to the additional PCI.

Note that in an alternative embodiment, the additionalPCIIndex and additionalPCI may not be explicitly configured as part of CFRA-Additional. Instead, each CFRA-Additional may be implicitly associated with additionalPCIIndex and additionalPCI parameters that are configured elsewhere (e.g., additionalPCIIndex and additionalPCI may be configured as part of the SSB-MTC-AdditionalPCI-r17 field as described in [2]).

Table 3 depicts an embodiment in which additionalPCIIndex and additionalPCI are configured as part of SSB-MTC-AdditionalPCI-r17, showing additional RACH configurations for the second TRP associated to an additional PCI.

TABLE 3
RACH-ConfigDedicated IE

| | |
|---|---|
| RACH-ConfigDedicated ::= | SEQUENCE { |

| | |
|---|---|
| cfra | CFRA |

OPTIONAL, -- Need S

| | |
|---|---|
| ra-Prioritization | RA-Prioritization |

```
OPTIONAL, -- Need N
  ...,
  [[
```

| | |
|---|---|
| ra-PrioritizationTwoStep-r16 | RA-Prioritization |
| OPTIONAL, -- Need N | |
| cfra-TwoStep-r16 | CFRA-TwoStep-r16 |

```
OPTIONAL -- Need S
  ]],
  [[
```

| | |
|---|---|
| cfra-Additional-r18 | CFRA-Additional-r18 OPTIONAL -- Need S |

]]
}

| | |
|---|---|
| CFRA-Additional-18 ::= | SEQUENCE { |
| occasionsAdditional-r18 | SEQUENCE { |
| additionalPCIIndex-r18 | AdditionalPCIIndex-r18, |

OPTIONAL -- Need R

| | |
|---|---|
| additionalPCI | PhysCellId, |

OPTIONAL -- Need R

| | |
|---|---|
| prach-RootSequenceIndex-r18 | CHOICE { |
| l839 | INTEGER (0..837), |
| l139 | INTEGER (0..137) |

} OPTIONAL -- Need R

| | |
|---|---|
| rach-ConfigGeneric-r18 | RACH-ConfigGeneric, OPTIONAL -- |

Need R

| | |
|---|---|
| ssb-perRACH-Occasion-r18 | ENUMERATED {oneEighth, oneFourth, |

```
oneHalf, one, two, four, eight, sixteen}
  OPTIONAL -- Need R
  }
}
AdditionalPCIIndex-r18 ::= INTEGER(1..maxNrofAdditionalPCI-r18)
```

In an alternative embodiment, the RACH-ConfigDedicated IE is extended to include additional RACH configurations associated to an additional PCIs as shown below in Table 4. In Table 4, a list of CFRA-Additional fields are configured wherein each CFRA-Additional field corresponds to one of a list of additional PCIs configured. Note that the list of additional PCIs is configured as part of MIMOParam-r17 in [2] where one SSB-MTC-AdditionalPCI-r17 is configured per additional PCI. Hence, it can be alternatively stated that each CFRA-Additional field corresponds to one of the SSB-MTC-AdditionalPCI-r17's configured. The contents of CFRA-Additional may be similar to the example in Table 3. Note that the additionalPCIIndex and additionalPCI may not be explicitly configured as part of CFRA-Additional. Instead, each CFRA-Additional may be implicitly associated with additionalPCIIndex and additionalPCI parameters that are configured as part of each of a list of SSB-MTC-AdditionalPCI-r17.

TABLE 4
A second example showing additional RACH configurations
for additional TRP(s) associated to additional PCI(s)

| | |
|---|---|
| RACH-ConfigDedicated ::= | SEQUENCE { |

| | |
|---|---|
| cfra | CFRA |

OPTIONAL, -- Need S

| | |
|---|---|
| ra-Prioritization | RA-Prioritization |

```
OPTIONAL, -- Need N
  ...,
  [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

```
OPTIONAL -- Need S
  ]],
  [[
```

| | |
|---|---|
| additionalCFRA-ToAddModList-r18 | SEQUENCE |
| (SIZE(1..maxNrofAdditionalPCI-r18)) OF CFRA-Additional-r18 | OPTIONAL -- Need |

S

| | |
|---|---|
| additionalCFRA-ToReleaseList-r18 | SEQUENCE (SIZE(1.. |

maxNrofAdditionalPCI-r18)) OF cfra-AdditionalId-r18 OPTIONAL -- Need S
]]
}

| CFRA-Additional-18 ::= | SEQUENCE { | |
|---|---|---|
| cfra-AdditionalId-r18 | CFRA-AdditionalId-r18 | |
| occasionsAdditional-r18 | SEQUENCE { | |
| additionalPCIIndex-r18 | AdditionalPCIIndex-r18, | OPTIONAL |

-- Need R

| | | |
|---|---|---|
| additionalPCI | PhysCellId, | OPTIONAL |

-- Need R

| | |
|---|---|
| prach-RootSequenceIndex-r18 | CHOICE { |
| l839 | INTEGER (0..837), |
| l139 | INTEGER (0..137) |

} OPTIONAL -- Need

| | |
|---|---|
| rach-ConfigGeneric-r18 | RACH-ConfigGeneric, OPTIONAL -- |

Need R

| | |
|---|---|
| ssb-perRACH-Occasion-r18 | ENUMERATED {oneEighth, oneFourth, |

```
oneHalf, one, two, four, eight, sixteen}
  OPTIONAL -- Need R
  }
}
AdditionalPCIIndex-r18 ::= INTEGER(1..maxNrofAdditionalPCI-r18)
```

In another embodiment, a separate IE associated to each additional PCI may be used to configure CFRA based PRACH.

In one embodiment, for PRACH initiated with PDCCH order, the IE CFRA is extended such that the field rach-ConfigGeneric is common to the original configuration and to one or more TRPs associated with the additional PCI(s). In this embodiment, number of SSBs per RACH Occasion (given by the parameter ssb-perRACH-Occasion2-r18) corresponding to an additional PCI can be configured as part of the extended CFRA as shown in Table 5. When there is more than one additional PCI configured, alternatively, a list of ssb-perRACH-Occasion2-r18 parameters may be configured as part of the CFRA IE where each ssb-perRACH-Occasion2-r18 in the list provides the number of SSBs per RACH Occasion corresponding to each of the additional PCI(s) in a list of additional PCI(s) configured to the UE.

TABLE 5
A first example showing extending CFRA configuration
for the second TRP associated to an additional PCI

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, |

oneHalf, one, two, four, eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB- |

Resources)) OF CFRA-SSB-Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS- |

Resources)) OF CFRA-CSIRS-Resource,

| | |
|---|---|
| rsrp-ThresholdCSI-RS | RSRP-Range |

```
    }
  },
  ...,
  [[
```

| | |
|---|---|
| totalNumberOfRA-Preambles | INTEGER (1..63) |

```
OPTIONAL -- Cond Occasions
  ]],
  [[
```

| | |
|---|---|
| ssb-perRACH-Occasion2-r18 | ENUMERATED {oneEighth, oneFourth, |
| oneHalf, one, two, four, eight, sixteen} | OPTIONAL -- |

Need R
]]
}

In one embodiment, for PRACH initiated with PDCCH order, the IE CFRA is extended such that both rach-ConfigGeneric and ssb-perRACH-Occasion are different between the first TRP and the TRP associated to the additional PCIs. An example of this extension is shown in Table 6. In this embodiment, rach-ConfigGeneric and ssb-perRACH-Occasion corresponding to an additional PCI can be configured as part of the extended CFRA as shown in Table 6. When there is more than one additional PCI configured, alternatively, a list of ssb-perRACH-Occasion-r18 parameters may be configured as part of the CFRA IE where each ssb-perRACH-Occasion-r18 in the list provides the number of SSBs per RACH Occasion corresponding to each of the additional PCI(s) in the list of additional PCI(s) configured to the UE. When there is more than one additional PCI configured, alternatively, a list of rach-ConfigGeneric-r18 parameters may be configured as part of the CFRA IE where each rach-ConfigGeneric-r18 in the list provides the configuration of CFRA corresponding to each of the additional PCI(s) in the list of additional PCI(s) configured to the UE.

In addition, as shown in Table 6, a PRACH root sequence index prach-RootSequenceIndex-r18 corresponding to an additional PCI can be configured as part of the extended CFRA. When there is more than one additional PCI configured, alternatively, a list of prach-RootSequenceIndex-r18 parameters may be configured as part of the CFRA IE where each prach-RootSequenceIndex-r18 in the list provides the PRACH root sequence index corresponding to each of the additional PCI(s) in the list of additional PCI(s) configured to the UE.

In some alternative embodiments, the additionalPCIIndex and additionalPCI may be explicitly configured as part of extended CFRA configuration. Alternatively, the additionalPCIIndex and additionalPCI may not be explicitly configured as part of the extended CFRA configuration. Instead, each extended element (e.g., any one or more of rach-ConfigGeneric-r18, ssb-perRACH-Occasion-r18, and prach-RootSequenceIndex-r18) may be implicitly associated with additionalPCIIndex and additionalPCI parameters that are configured elsewhere (e.g., additionalPCIIndex and additionalPCI may be configured as part of the SSB-MTC-AdditionalPCI-r17 field as described in [2]).

TABLE 6
A second example of extending CFRA IE for additional PCI(s)

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, |

two, four, eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF |

CFRA-SSB-Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF |

CFRA-CSIRS-Resource,

| | |
|---|---|
| rsrp-ThresholdCSI-RS | RSRP-Range |

```
    }
  },
  ...,
  [[
```

| | | |
|---|---|---|
| totalNumberOfRA-Preambles | INTEGER | (1..63) |

```
OPTIONAL -- Cond Occasions
  ]],
  [[
```

| | |
|---|---|
| Occasions2-r18 | SEQUENCE { |
| rach-ConfigGeneric-r18 | RACH-ConfigGeneric, |
| ssb-perRACH-Occasion-r18 | ENUMERATED {oneEighth, oneFourth, oneHalf, |

one, two, four, eight, sixteen}

| | |
|---|---|
| additionalPCIIndex-r18 | AdditionalPCIIndex-r18, |
| additionalPCI | PhysCellId, |
| prach-RootSequenceIndex-r18 | CHOICE { |
| l839 | INTEGER (0..837), |
| l139 | INTEGER (0..137) |

| | |
|---|---|
| } OPTIONAL -- Need R | |
| OPTIONAL -- Cond Mandatory | |
| } | ]] |
| } | |

In one embodiment, for UE initiated PRACH, if the UE is configured with additional PCI/SSB, the IE CFRA-SSB-Resource used in IE PRACH-ConfigDedicated is extended with the additional PCI index as shown in Table 7.

TABLE 7
CFRA-SSB-Resource IE

| | |
|---|---|
| CFRA-SSB-Resource ::= | SEQUENCE { |
| ssb | SSB-Index, |
| ra-PreambleIndex | INTEGER (0..63), |

```
  ...,
  [[
```

| | | |
|---|---|---|
| msgA-PUSCH-Resource-Index-r16 | INTEGER (0..3071) | OPTIONAL -- Cond |

```
2StepCFRA
  ]],
  [[
```

| | |
|---|---|
| additionalPCI-r18 | AdditionalPCIIndex-r18 |

OPTIONAL -- Need R
]]
}

In Table 7, additionalPCI indicates the physical cell IDs (PCI) of the SSBs. It refers to a PCI value configured in a list additionalPCI-ToAddModList configured in the serving cell in which the UE performs the RACH.

To extend the CSI-RS resource for PRACH, there are two options. In a first option, the non-zero power (NZP) CSI-RS id is used which enables association of any NZP CSI RS configured for a serving cell, which means also such NZP CSI-RS can be associated to additionalPCI in a TCI state configuration as shown in Table 8.

TABLE 8
CFRA-CSIRS-Resource IE

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) |

OF INTEGER (0..maxRA-Occasions-1),

| | |
|---|---|
| ra-PreambleIndex | INTEGER (0..63), |

```
  ...,
  [[
```

| | | |
|---|---|---|
| csi-rs-additional-r18 | NZP-CSI-RS-ResourceId | OPTIONAL |

-- Need R
]]
}
CFRA-CSIRS-Resource field descriptions
csi-RS
The ID of a CSI-RS resource defined in the measurement object associated with this serving cell.
csi-rs-additional
The ID of a CSI-RS resource defined in CSI-measConfig associated to an additionalPCI in IE TCI state.
ra-OccasionList
RA occasions that the UE shall use when performing CF-RA upon selecting the candidate beam identified by this CSI-RS.
The network ensures that the RA occasion indexes provided herein are also configured by prach-ConfigurationIndex and
msg1-FDM. Each RACH occasion is sequentially numbered, first, in increasing order of frequency resource indexes for
frequency multiplexed PRACH occasions; second, in increasing order of time resource indexes for time multiplexed
PRACH occasions within a PRACH slot and Third, in increasing order of indexes for PRACH slots.
ra-PreambleIndex
The RA preamble index to use in the RA occasions associated with this CSI-RS.

In a second option, the CSI-RS defined in the measurement object is extended as shown in Table 9.

TABLE 9
CSI-RS-ResourceConfigMobility IE

| | |
|---|---|
| CSI-RS-ResourceConfigMobility ::= | SEQUENCE { |
| subcarrierSpacing | SubcarrierSpacing, |
| csi-RS-CellList-Mobility | SEQUENCE (SIZE (1..maxNrofCSI-RS- |

```
CellsRRM)) OF CSI-RS-CellMobility,
  ...,
  [[
```

| | |
|---|---|
| refServCellIndex | ServCellIndex |

OPTIONAL -- Need S
]]
}

| | |
|---|---|
| CSI-RS-CellMobility ::= | SEQUENCE { |
| cellId | PhysCellId, |
| csi-rs-MeasurementBW | SEQUENCE { |
| nrofPRBs | ENUMERATED { size24, size48, size96, |

size192, size264},

| | |
|---|---|
| startPRB | INTEGER(0..2169) |

},

| | |
|---|---|
| density | ENUMERATED {d1,d3} |

OPTIONAL, -- Need R

| | |
|---|---|
| csi-rs-ResourceList-Mobility | SEQUENCE (SIZE (1..maxNrofCSI-RS- |

ResourcesRRM)) OF CSI-RS-Resource-Mobility
}

| | |
|---|---|
| CSI-RS-Resource-Mobility ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

},

| | |
|---|---|
| associatedSSB | SEQUENCE { |
| ssb-Index | SSB-Index, |
| isQuasiColocated | BOOLEAN |

}
OPTIONAL, -- Need R

| | |
|---|---|
| frequencyDomainAllocation | CHOICE { |
| row1 | BIT STRING (SIZE (4)), |
| row2 | BIT STRING (SIZE (12)) |

},

| | |
|---|---|
| firstOFDMSymbolInTimeDomain | INTEGER (0..13), |
| sequenceGenerationConfig | INTEGER (0..1023), |

```
  ...,
  [[
```

| | |
|---|---|
| slotConfig-r17 | CHOICE { |
| ms4 | INTEGER (0..255), |
| ms5 | INTEGER (0..319), |
| ms10 | INTEGER (0..639), |
| ms20 | INTEGER (0..1279), |
| ms40 | INTEGER (0..2559) |

```
  }
OPTIONAL -- Need R
  ]] ,
  [[
```

| | |
|---|---|
| additionalPCI-r18 | AdditionalPCIIndex-r18 |

OPTIONAL -- Need R
]]
}

| | |
|---|---|
| CSI-RS-Index ::= | INTEGER (0..maxNrofCSI-RS-ResourcesRRM-1) |

-- TAG-CSI-RS-RESOURCECONFIGMOBILITY-STOP
-- ASN1STOP

In Table 9, additionalPCI Indicates the PCI of the SSBs for the associatedSSB. It refers to a PCI value configured in a list additionalPCI-ToAddModList configured in the serving cell UE in which the performs the RACH.

In another embodiment, the PRACH configuration is not extended for the additional PCIs but it is specified that when a UE receives a PDCCH order concerning a TRP which is associated to an additional PCI, UE applies the original PRACH configuration towards that PCI/SSB/TRP. The PRACH configuration may be dedicated or common. The original PRACH configuration, dedicated or common, may be the PRACH configuration given for the cell group which the TRP associated to the PDCCH order belongs to.

In a third embodiment, the first TRP associated to the serving cell PCI/SSB uses the original CFRA configuration and the second TRP receives a RACH configuration using IE BeamFailureRecoveryConfig. Similar to embodiments 1 and 2, each 7 additional PCI/SSB may receive either its own RACH configuration or only the root sequence. In a variant, also the first TRP receives an additional CFRA configuration using IE BeamFailureRecoveryConfig.

In another embodiment, a TRP may be associated with a PRACH configuration using the beamfailurerecovery configuration. This configuration may be implicit such that UE assumes the same configuration as configured for beam failure recovery. Or, it may be a new field using the IE BeamFailureRecoveryConfig. The PCI linked to the SSB pointed out in this configuration is assumed to be the PCI which is currently active for the second TRP. For the first TRP, the PCI is that of the original serving cell.

In a fourth embodiment, the first TRP associated to the serving cell PCI/SSB uses the original CFRA configuration and the second TRP receives a RACH configuration using a new IE. Similar to the first and second embodiments, each 7 additional PCI/SSB may receive either it's own RACH configuration or only the root sequence. In a variant, also the first TRP receives an additional CFRA configuration using a new IE. Details of the new IE are given below.

In one embodiment, a new configuration IE is defined with which UE is configured with RACH resources and SSBs for regaining the UL time synchronization per TRP if the associated time alignment timer expires. The configuration is not specific to PCI/SSB but applies to any active additional PCI/SSB. In a variant, the same configuration applies to the TRP associated to the original PCI of the serving cell.

This new IE contains one or more higher layer parameters or IEs that may be configured for CFRA based PRACH transmission associated to the additional PCI. Such higher layer parameters may include a PRACH root sequence index or a CFRA IE. The CFRA IE may include a RACH-ConfigGeneric IE, a ssb-perRACH-Occasion, a CFRA-SSB-Resource IE and/or a CFRA-CSIRS-Resource IE.

Another example of this new IE is shown in Table 10.

TABLE 10
RACH-ConfigAdditional IE

RACH-ConfigAdditional ::= SEQUENCE {

| | |
|---|---|
| rach-ConfigGeneric | RACH-ConfigGeneric, OPTIONAL -- Need |

R

| | |
|---|---|
| ssb-perRACH-Occasion | ENUMERATED {oneEighth, oneFourth, |

oneHalf, one, two, four, eight, sixteen}
OPTIONAL -- Need R
}

With this IE, the UE may be configured with RACH resources for the both TRPs or the second TRP, for example in the servingcellConfig IE. Optionally, if the configuration is cell group specific, it may be given in the cell group configuration in the IE CellGroupConfig. Optionally, the configuration may be common to TRPs following the same TAG ID of the serving cells configured for the UE.

In a fifth embodiment, in relation to the third and fourth embodiments, when one TRP specific timing advance timer expires, the UE uses the RACH configuration given in IE BeamFailureRecoveryConfig or in the new IE. When both timers expire, the UE uses the original CFRA configuration.

In a sixth embodiment, in relation to the third and fourth embodiments, a UE may receive a PDCCH order to use the RACH configuration given in the IE BeamFailureRecoveryConfig or in the new IE. UE may also receive a PDCCH order to use the original CFRA configuration.

In one embodiment, targeting to intracell case, SSBs of the original serving cell are associated/shared to TRP1 and TRP2.

In one embodiment, the ssb-perRACH-OccasionAndCB-PreamblesPerSSB parameter in the rach-ConfigCommon IE includes a new IE, e.g., ssbAdditionalPerRachOccasionAndCF-Preambles-r18 for which additional SSBs may be signalled such that for shared RACH occasions the SSBs (e.g. available for CFRA) are expanded. By this, additional SSBs can be configured (for the additional TRP/PCI) and the total number of preambles per corresponding CFRA SSB(s) can be partitioned and configured.

TABLE 11
BWP-UplinkCommon IE

| | |
|---|---|
| BWP-UplinkCommon ::= | SEQUENCE { |
| genericParameters | BWP, |
| rach-ConfigCommon | SetupRelease { RACH-ConfigCommon } |

OPTIONAL, -- Need M
-- omitted -

| | |
|---|---|
| RACH-ConfigCommon ::= | SEQUENCE { |
| rach-ConfigGeneric | RACH-ConfigGeneric, |

| | |
|---|---|
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |

```
-- omitted - }
  ssbAdditionalPerRachOccasionAnsCF-Preambles-r18 [
    {
      startPreambleForThisPartition-r17 = n, --(#partitions□
list/seq?)
      nrofPreamblesForThisPartition-r17 = m,
      ssb-SharedRO-MaskIndex-r17 = tbd −(could also be used to
only use some preambles)
        ...
```

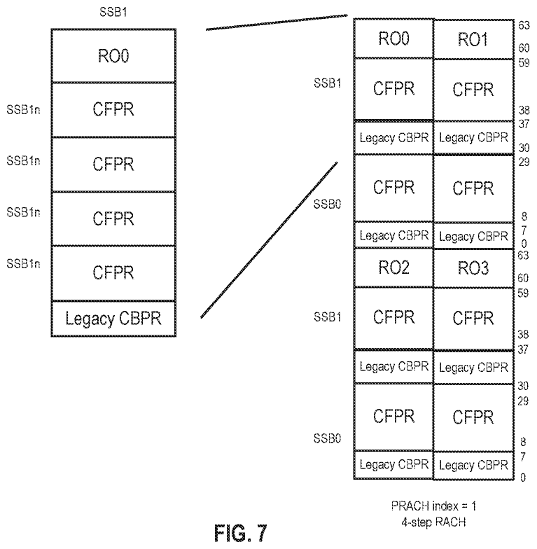

FIG. 7 illustrates a detail of a mapping of contention free preambles (CFPR) to an SSB for PRACH index=1 and a 4-step RACH procedure.

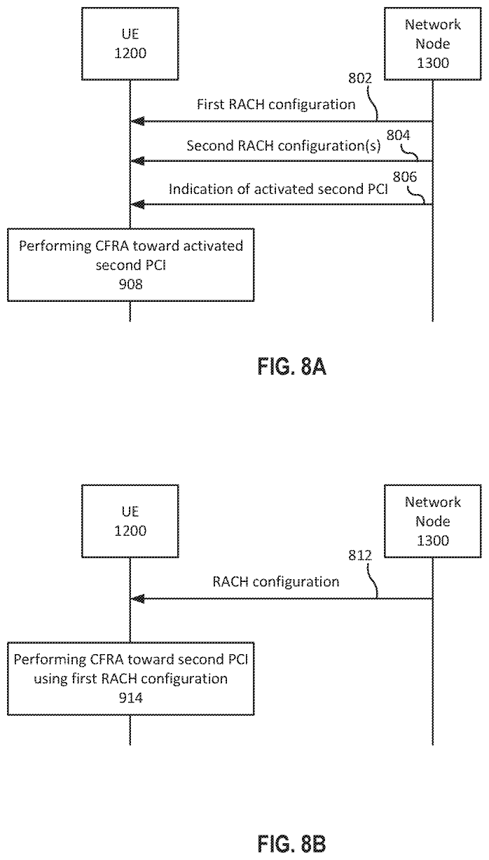

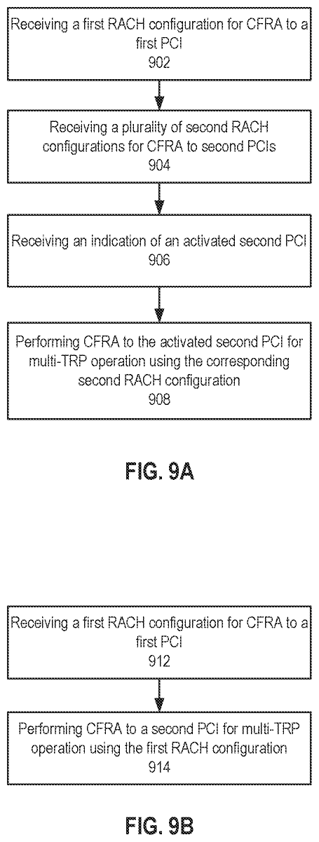

FIG. 8A is a signal flow diagram illustrating message flows according to some embodiments, and FIG. 9A illustrates a method performed by a UE 1200 in a wireless communication network. Referring to FIGS. 8 and 9A, the UE 1200 is configured with two TAGs and is configured with a first CORESET associated to a first CORESET pool index and a second CORESET associated to a second CORESET pool index. The method includes receiving (block 902) a first RACH configuration 802 associated to a first PCI for CFRA wherein the first PCI is associated to the first CORESET.

At block 904, the UE receives one or more second RACH configurations 804 associated to one or more respective second PCIs for CFRA, where the one or more second PCIs are associated to the second CORESET. The first and second RACH configurations have been described earlier.

At block 906, the UE receives an indication 806 of an activated second PCI of the one or more second PCIs and a request of CFRA associated to the activated second PCI. In response to receiving the indication, the UE performs, at block 908, a CFRA according to one of the one or more second RACH configurations associated to the activated second PCI.

FIG. 8B is a signal flow diagram illustrating message flows according to further embodiments, and FIG. 9B illustrates operations of a method performed by a UE 1200 in a wireless communication network according to further embodiments. Referring to FIGS. 8B and 9B, the UE receives (block 912) a first RACH configuration 812 for CFRA, to a first physical cell identity, PCI, associated with a first CORESET, associated to a first CORESET pool index. The UE performs (block 914) a CFRA toward a second PCI for multi-TRP operation using the first RACH configuration.

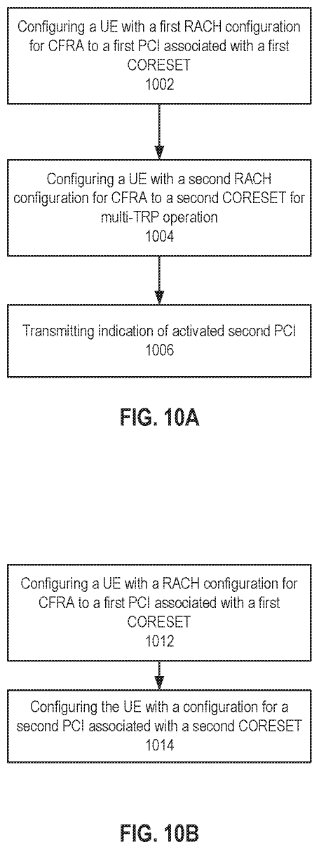

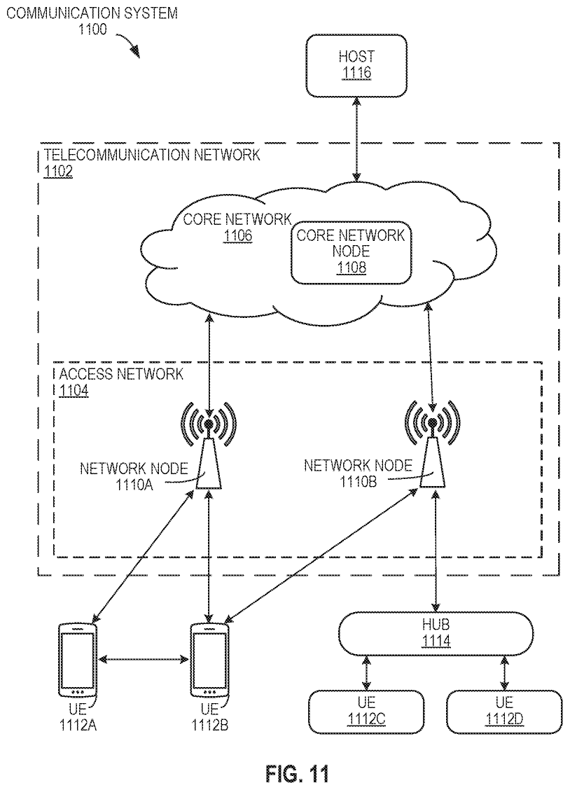

FIG. 10A illustrates a method performed by network node (1300) in a wireless communication network according to some embodiments. Referring to FIGS. 8A and 10A, the network node 1300 configures (block 1002) a UE 1200 with a first RACH configuration 802 for CFRA to a first PCI associated with a first CORESET associated to a first CORESET pool index. The network node 1300 configures (block 1004) the UE with a plurality of second RACH configurations 804 for a respective second plurality of PCIs associated to a second CORESET that is associated to a second CORESET pool index for multi-TRP operation. The network node 1300 then transmits (block 1006) an indication 806 of an activated second PCI of the one or more second PCIs and a request of CFRA associated to the activated second PCI.

FIG. 10B illustrates operations of a method performed by a network node 1300 in a wireless communication network according to further embodiments. Referring to FIGS. 8B and 10B, the network node 1300 configures (block 1012) a UE 1200 with a RACH configuration 812 for CFRA to a first PCI associated with a first CORESET associated to a first CORESET pool index, and configures (block 1014) the UE with a configuration for a second PCI associated with a second CORESET for multi-TRP operation. The UE applies the RACH configuration when performing a CFRA to the second PCI for multi-TRP operation. The RACH configuration and the configuration for the second PCI have been described earlier.

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1102 includes one or more Open-RAN (ORAN) network nodes. An ORAN network node is a node in the telecommunication network 1102 that supports an ORAN specification (e.g., a specification published by the O-RAN Alliance, or any similar organization) and may operate alone or together with other nodes to implement one or more functionalities of any node in the telecommunication network 1102, including one or more network nodes 1110 and/or core network nodes 1108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

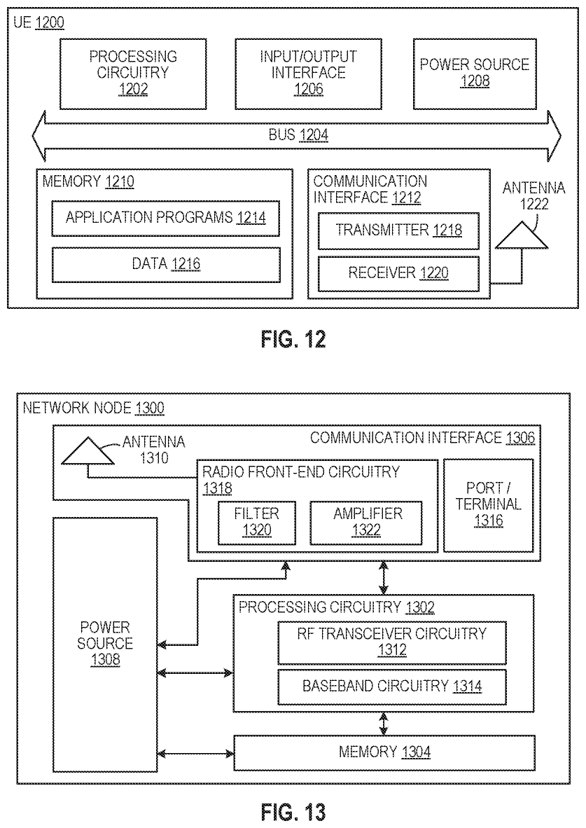

FIG. 12 shows a UE 1200 in accordance with some embodiments. In particular, a UE 1200 may be configured to perform the operations described above in connection with FIGS. 8A, 8B, 9A and 9B. As used herein, a UE refers to a device capable, configured, arranged and/or operable to communicate wirelessly with network nodes and/or other UEs. Examples of a UE include, but are not limited to, a smart phone, mobile phone, cell phone, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera, a smartcard, and the like. The presence-sensitive display may include a capacitive or resistive touch sensor to sense input from a user. A sensor may be, for instance, an accelerometer, a gyroscope, a tilt sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable ROM (PROM), erasable PROM (EPROM), electrically erasable PROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. In particular, a network node 1300 may be configured to perform the operations described above in connection with FIGS. 8A, 8B, 10A and 10B. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

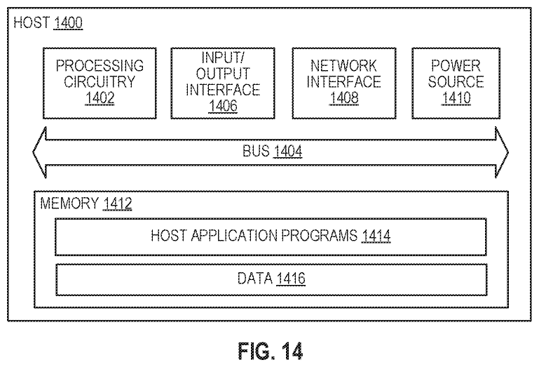

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1] 3GPP TS 38.211 v 17.4.0
[2] 3GPP TS 38.331 v 17.4.0
[3] 3GPP TS 38.321 v 17.4.0

1. A method performed by a user equipment (UE) in a wireless communication network, wherein the UE is configured with two timing advance groups, (TAGs) and is configured with a first Control Resource Setz, (CORESET) associated to a first CORESET pool index and a second CORESET associated to a second CORESET pool index, the method comprising:
receiving a first random access channel (RACH) configuration associated to a first physical cell identity (PCI) for contention free random access (CFRA) wherein the first PCI is associated to the first CORESET;
receiving one or more second RACH configurations associated to one or more respective second PCIs for CFRA, wherein the one or more second PCIs are associated to the second CORESET;
receiving an indication of an activated second PCI of the one or more second PCIs and a request of CFRA associated to the activated second PCI; and
performing a CFRA according to one of the one or more second RACH configurations associated to the activated second PCI.

2. The method of claim 1, wherein the first and the second CORESETs are associated to first and second transmission and reception points, (TRPs) respectively.

3. The method of claim 1, wherein the indication and the request are carried in a Physical Downlink Control Channel, PDCCH (PDCCH).

4. The method of claim 1, wherein the first CORESET pool index and the second CORESET pool index are different.

5. The method of claim 1, wherein each of the one or more second RACH configurations comprises a root sequence for generating a random access preamble for performing the random access, the method further comprising using the root sequence of the corresponding one of the second RACH configurations when performing the CFRA according to the activated PCI.

6. The method of claim 1, wherein each of the one or more second RACH configurations further comprises information of the respective second PCI value and information of RACH occasions.

7. The method of claim 1, wherein each of the one or more second RACH configurations further comprises information of generic RACH parameters.

8. The method of claim 1, wherein the one or more second RACH configurations are provided as part of a dedicated RACH configuration.

9. The method of claim 1, wherein the one or more second RACH configurations are provided as part of a common RACH configuration associated with a cell group associated with the second CORESET pool index.

10. The method of claim 1, wherein the one or more second RACH configurations are received as part of a beam failure recovery configuration.

11. The method of claim 1, wherein the UE is configured with a TA timer, and wherein the UE applies the second RACH configuration upon expiration of the TA timer.

12. The method of claim 1, wherein the one or more second RACH configurations comprise respective physical random access channel, PRACH, group sequences.

13-19. (canceled)

20. A method performed by network node in a wireless communication network, comprising:
configuring a user equipment (UE) with a first random access channel, RACH configuration for contention free random access (CFRA) to a first physical cell identity (PCI) associated with a first Control Resource Set (CORESET) associated to a first CORESET pool index; and
configuring the UE with a plurality of second RACH configurations for a respective second plurality of PCIs associated to a second CORESET that is associated to a second CORESET pool index for multi-transmission reception point, (TRP) operation.

21. The method of claim 20, wherein the first and the second CORESETs are associated to first and a second TRPs respectively.

22. The method of claim 20, further comprising:
configuring the UE with a plurality of respective second RACH configurations associated with respective PCIs associated with the second CORESET, wherein the UE applies a respective second RACH configuration when performing a CFRA to a respective PCI associated with the second CORESET.

23. The method of claim 20, wherein the second RACH configuration comprises a root sequence for generating a random access preamble for performing the random access to the PCI associated with the second CORESET, wherein the UE applies the RACH configuration using the root sequence when performing the CFRA to the PCI associated with the second CORESET.

24. The method of claim 20, wherein the second RACH configuration is provided as part of a dedicated RACH configuration.

25. The method of claim 20, wherein the second RACH configuration is provided as part of a common RACH configuration associated with a cell group associated with the second CORESET.

26. The method of claim 20, wherein the second RACH configuration is provided as part of a beam failure recovery configuration.

27-30. (canceled)

31. A user equipment (UE) configured with two timing advance groups (TAGs) and is configured with a first Control Resource Setz (CORESET) associated to a first CORESET pool index and a second CORESET associated to a second CORESET pool index, the UE comprising:
processing circuitry; and
memory coupled to the processing circuitry and having instructions stored therein that is executable by the processing circuitry to cause the UE to perform operations comprising:
receiving a first random access channel (RACH) configuration associated to a first physical cell identity (PCI) for contention free random access (CFRA) wherein the first PCI is associated to the first CORESET;
receiving one or more second RACH configurations associated to one or more respective second PCIs for CFRA, wherein the one or more second PCIs are associated to the second CORESET;
receiving an indication of an activated second PCI of the one or more second PCIs and a request of CFRA associated to the activated second PCI; and
performing a CFRA according to one of the one or more second RACH configurations associated to the activated second PCI.

32-33. (canceled)
